(19) United States
(12) Patent Application Publication
(10) Pub. No.: US 2026/0111327 A1
(43) Pub. Date: Apr. 23, 2026

(54) Method and apparatus for controlling indicating apparatus, server, and medium

(71) Applicant: SUZHOU METABRAIN INTELLIGENT TECHNOLOGY CO.,LTD., Suzhou, Jiangsu (CN)

(72) Inventors: Xiaopeng ZHANG, Suzhou, Jiangsu (CN); Xiaoyan QI, Suzhou, Jiangsu (CN); Youyi ZHOU, Suzhou, Jiangsu (CN); Kai XUE, Suzhou, Jiangsu (CN); Liguo YUAN, Suzhou, Jiangsu (CN); Tao WANG, Suzhou, Jiangsu (CN)

(73) Assignee: SUZHOU METABRAIN INTELLIGENT TECHNOLOGY CO.,LTD., Suzhou, Jiangsu (CN)

(21) Appl. No.: 19/167,622

(22) PCT Filed: Sep. 29, 2024
(86) PCT No.: PCT/CN2024/122172

§ 371 Date: Sep. 22, 2025

(30) Foreign Application Priority Data
Feb. 29, 2024 (CN) 202410232080.7

(51) Int. Cl. G06F 11/30; G06F 11/07

(52) U.S. Cl. CPC G06F 11/3058; G06F 11/0772

(57) ABSTRACT

A method and apparatus for controlling an indicating apparatus, a server, and a medium is provided. The method includes acquiring a current pending setting state of the indicating apparatus corresponding to a target device. Acquiring a current refresh state and a previous refresh state prior to the current time of a programmable logic device on a target board. The target board is connected to the indicating apparatus, and the target device is arranged on the target board. Determining the update of the logic device on the target board is complete when the current refresh state and the previous refresh state meet preset requirements. Writing data correspondingly representing the current pending setting state into the logic device on the target board, when a baseboard management controller is operational, to control a state of the indicating apparatus to the current pending setting state through the logic device on the target board.

### CROSS-REFERENCE TO RELATED DISCLOSURE

This disclosure is a national stage filing under 35 U.S.C. § 371 of international application number PCT/CN2024/122172, filed Sep. 29, 2024, which claims priority to Chinese Patent Application No. 202410232080.7, filed with the China National Intellectual Property Administration on Feb. 29, 2024, and entitled “METHOD AND APPARATUS FOR CONTROLLING INDICATING APPARATUS, SERVER, AND MEDIUM”, the entire contents of each of which are incorporated herein by reference for all purposes.

### TECHNICAL FIELD

This disclosure relates to a method and apparatus for controlling an indicating apparatus, a server, and a medium.

### BACKGROUND

There are various types of boards in a hardware composition of a server. A variety of devices and indicating apparatuses representing device states may be inserted onto the boards. A baseboard management controller (BMC) indirectly controls the devices and the indicating apparatuses corresponding to the devices by reading from and writing to registers exposed externally by a complex programmable logic device (CPLD).

As business requirements increase, the functions of the CPLD may change. In this case, the CPLD on the board needs to be updated, such that a new CPLD mirror image can take effect. After the CPLD is updated, values in all register lists within the CPLD will revert to default values. Consequently, functions that are indirectly controlled by the BMC writing to the CPLD will all return to default states. When the indicating apparatus is in a default state (e.g., an indicator is in an off state), a user may mistakenly determine or be unable to determine an operating state of the device based on the state of the indicating apparatus.

Thus, after updating the CPLD, how to maintain the indicating apparatus in the state before the update of the CPLD to allow the user to accurately understand the operating state of the device through the indicating apparatus is a technical problem that urgently needs to be solved by those skilled in the art.

### SUMMARY

According to embodiments of this disclosure, in a first aspect, a method for controlling an indicating apparatus is provided and applied to a baseboard management controller of a motherboard, including:
acquiring a current pending setting state of the indicating apparatus corresponding to a target device;
acquiring a current refresh state and a previous refresh state prior to the current time of a complex programmable logic device on a target board, where the refresh state includes an unrefreshed state, a refreshing state, and a refresh-completed state; and the target board is a board to which the indicating apparatus is connected, and the target device is a device arranged on the target board;
determining, in a case of detecting that the current refresh state and the previous refresh state meet preset requirements, that the update of the complex programmable logic device on the target board is complete; and
writing, in a case of a baseboard management controller being operational, data correspondingly representing the current pending setting state into the complex programmable logic device on the target board, so as to control a state of the indicating apparatus to the current pending setting state through the complex programmable logic device on the target board.

According to the embodiments of this disclosure, in a second aspect, an apparatus for controlling an indicating apparatus is further provided and applied to a baseboard management controller of a motherboard, including:
a first acquiring module, configured to acquire a current pending setting state of the indicating apparatus corresponding to a target device;
a second acquiring module, configured to acquire a current refresh state and a previous refresh state prior to the current time of a complex programmable logic device on a target board, where the refresh state includes an unrefreshed state, a refreshing state, and a refresh-completed state; and the target board is a board to which the indicating apparatus is connected, and the target device is a device arranged on the target board;
a detection and determination module, configured to determine, in a case of detecting that the current refresh state and the previous refresh state meet preset requirements, that the update of the complex programmable logic device on the target board is complete; and
a writing module, configured to write, in a case of the baseboard management controller being operational, data correspondingly representing the current pending setting state into the complex programmable logic device on the target board, so as to control a state of the indicating apparatus to the current pending setting state through the complex programmable logic device on the target board.

According to the embodiments of this disclosure, in a third aspect, a server is further provided, including:
a memory, configured to store computer-readable instructions; and
a processor, configured to implement, when executing the computer-readable instructions, the steps of the foregoing method for controlling an indicating apparatus.

According to the embodiments of this disclosure, in a fourth aspect, this disclosure further provides a non-transitory computer-readable storage medium, wherein computer-readable instructions are stored in the non-transitory computer-readable storage medium, and the computer-readable instructions are configured to cause, when executed by processor, the processor to perform the steps of the foregoing method for controlling an indicating apparatus.

Details of one or more embodiments of this disclosure are provided in the accompanying drawings and descriptions below. Other features and advantages of this disclosure become apparent from the specification, the accompanying drawings, and the claims.

### BRIEF DESCRIPTION OF THE DRAWINGS

To describe embodiments of this disclosure more clearly, the following briefly introduces accompanying drawings required for describing the embodiments. Apparently, the accompanying drawings in the following description are merely some embodiments of this disclosure, and those of ordinary skill in the art may also derive other accompanying drawings from these accompanying drawings without creative efforts.

FIG. 1 is a flowchart of a method for controlling an indicating apparatus according to an embodiment of this disclosure;

FIG. 2 is a flowchart of a method for acquiring a fan state according to an embodiment of this disclosure;

FIG. 3 is a flowchart of a method for updating a complex programmable logic device according to an embodiment of this disclosure;

FIG. 4 is a flowchart of a method for refreshing a complex programmable logic device during a power cycle according to an embodiment of this disclosure;

FIG. 5 is a flowchart of a method for controlling a lighting module according to an embodiment of this disclosure;

FIG. 6 is an architectural diagram of the maintenance of a fan light state after updating a complex programmable logic device on a fan board according to an embodiment of this disclosure;

FIG. 7 is a schematic structural diagram of an apparatus for controlling an indicating apparatus according to one or more embodiments of this disclosure;

FIG. 8 is a schematic structural diagram of a server according to another one or more embodiments of this disclosure; and

FIG. 9 is a structural schematic diagram of a non-transitory computer-readable storage medium according to an embodiment of this disclosure.

### DETAILED DESCRIPTION OF THE EMBODIMENTS

Technical solutions in embodiments of this disclosure are clearly and completely described below in combination with accompanying drawings in the embodiments of this disclosure, and it is apparent that the described embodiments are merely a part rather all of the embodiments of this disclosure. All other embodiments obtained by those of ordinary skill in the art based on the embodiments of this disclosure without creative efforts shall fall within the scope of protection of this disclosure.

The core of this disclosure is to provide a method and apparatus for controlling an indicating apparatus, a server, and a medium, to solve the technical problem that after the update of a CPLD, the indicating apparatus remains in a default state, causing a user to mistakenly determine or be unable to determine an operating state of a device based on a state of the indicating apparatus.

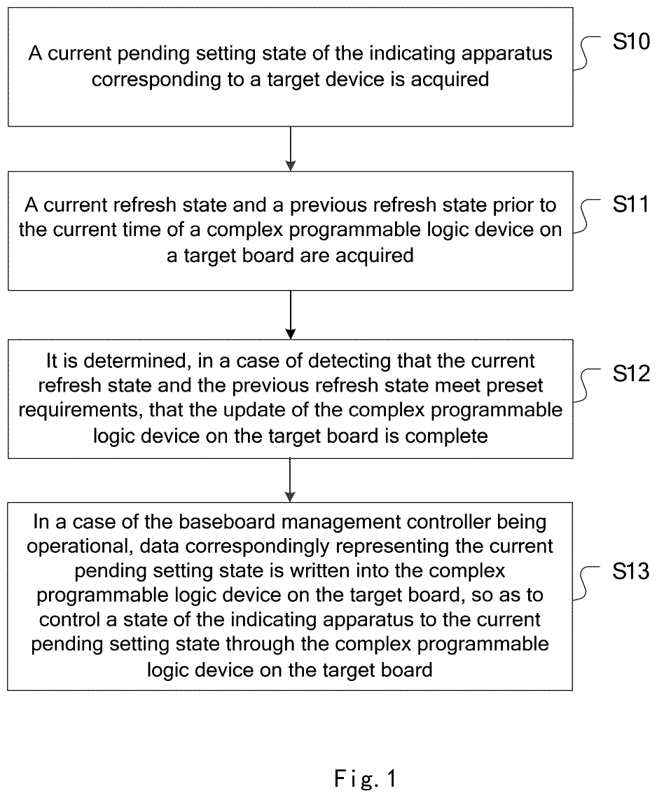

To facilitate a better understanding of the solutions of this disclosure by those skilled in the art, this disclosure is further described in detail below in combination with the accompanying drawings and specific implementations. The method for controlling an indicating apparatus according to this embodiment of this disclosure is applied to a baseboard management controller of a motherboard. FIG. 1 is a flowchart of a method for controlling an indicating apparatus according to an embodiment of this disclosure. As shown in FIG. 1, the method may include the following steps.

At S10, a current pending setting state of the indicating apparatus corresponding to a target device is acquired.

At S11, a current refresh state and a previous refresh state prior to the current time of a complex programmable logic device on a target board are acquired, where the refresh state includes an unrefreshed state, a refreshing state, and a refresh-completed state.

At S12, it is determined, in a case of detecting that the current refresh state and the previous refresh state meet preset requirements, that the update of the complex programmable logic device on the target board is complete.

At S13, in a case of the baseboard management controller being operational, data correspondingly representing the current pending setting state is written into the complex programmable logic device on the target board, so as to control a state of the indicating apparatus to the current pending setting state through the complex programmable logic device on the target board.

A hardware composition of a server includes various boards, such as a motherboard, a fan board, a power board, an input/output (IO) board, etc. These boards are essential components of the server, on which various devices may be inserted, such as a central processing unit (CPU), an internal memory, a hard disk, a graphics processing unit (GPU) card, a fan, and a power module. The board is further provided with the indicating apparatus for representing a device state. The indicating apparatus is typically an indicator, a buzzer, etc. Taking the fan board as an example, the fan board is an important type among these boards, with a fan inserted thereon to control fan rotation, thereby reducing server temperatures to prevent server damage caused by too high temperatures. The fan board is also provided with a light emitting diode (LED) for representing a fan state. An on/off state and color of the LED lamp may be used to determine a current state of the fan, such as whether the fan is inserted, whether there is a fan failure, or whether a rotational speed of the fan is too low.

The target board refers to a board on the server, and when a specific indicating apparatus is controlled, the board connected to the indicating apparatus is the target board. The target device refers to a device arranged on the target board, and when a specific indicating apparatus is controlled, an operating state of the target device is reflected by the indicating apparatus. There are no limitations on the type and quantity of target boards or target devices, which are determined according to actual situations. For example, the target board enumerated above is the fan board, the target device is the fan on the fan board, and the indicating apparatus is the indicator on the fan board.

Since the operating state of the target device may change in practice, to allow the user to accurately understand the operating state of the target device through the indicating apparatus, the operating state of the indicating apparatus corresponding to the target device may also change with the operating state of the target device, in practice, a state set for the indicating apparatus corresponding to the target device may also change each time. The current pending setting state of the indicating apparatus is not limited, which may be set according to user requirements. However, to allow the indicating apparatus to accurately reflect the operating state of the device, in some embodiments, acquiring a current pending setting state of an indicating apparatus corresponding to a target device includes the following steps.
a presence state of the target device is acquired;
it is determined, in a case of detecting that the target device is not present, the current pending setting state of the indicating apparatus corresponding to the target device as a first state;
in a case of detecting that the target device is present, an attribute value of the target device is acquired, where an attribute of the target device is determined according to a type of the target device;
the current pending setting state of the indicating apparatus corresponding to the target device is determined as a second state if it is detected that the attribute value is greater than or equal to a threshold; and
it is determined the current pending setting state of the indicating apparatus corresponding to the target device as a third state in a case of detecting that the attribute value is less than the threshold.

To acquire the presence state and the attribute value of the target device, an attribute table is established in this embodiment of this disclosure. The attribute table is a method of storing data that may be used for data interaction between different processes. Specifically, when acquiring the presence state of the target device (i.e., whether the device is inserted or not inserted into the board), a register for storing presence state data of the target device is read through an integrated circuit bus and address where the complex programmable logic device on the target board is located; the presence state data of the target device read from the register for storing the presence state data of the target device is stored in the attribute table; and the presence state of the target device is acquired from the attribute table.

When acquiring the attribute value of the target device, a register for storing the attribute value of the target device is read through the integrated circuit bus and address where the complex programmable logic device on the target board is located; the attribute value of the target device read from the register for storing the attribute value of the target device is stored in the attribute table; and the attribute value of the target device is acquired from the attribute table. After acquiring the attribute value, the attribute value is compared with the threshold to determine the current pending setting state of the indicating apparatus. The threshold is not limited, which is determined according to actual situations.

Controlling a current pending setting state of a fan light on the fan board is used as an example for describing the process of determining the current pending setting state. To facilitate user understanding, some functions of the fan board are described first before describing the control over the current pending setting state of the fan light on the fan board. The rotation of the fan and the state of the fan light are directly controlled by the complex programmable logic device. The complex programmable logic device is a type of digital circuit integrated circuit, commonly used to implement various logic circuits, state machines, timing control, or other functions. Whether the fan is present, the fan rotational speed, and how the fan light illuminates are all directly controlled by the complex programmable logic device. The complex programmable logic device exposes a set of register lists to other controllers. The other controllers may indirectly control the states of the fan and the fan board by reading from and writing to the register lists. For example, the baseboard management controller may determine whether the fan is inserted by reading specific registers of the complex programmable logic device and may indirectly control the fan rotational speed and the state of the fan light by writing to specific registers.

Some functions of the fan board are typically implemented through the following cooperation of the complex programmable logic device and the baseboard management controller: 1, fan presence state, which is controlled by the complex programmable logic device, where for presence and absence, the complex programmable logic device writes different values to specific registers, and the baseboard management controller may read the values to determine whether the fan is present; 2, fan rotational speed, which is indirectly controlled by the baseboard management controller through writing to the complex programmable logic device, where various devices are plugged into various boards of the server, the devices are provided with temperature sensors, the baseboard management controller acquires device temperatures by reading values of these temperature sensors, and then calculates a required pulse width modulation (PWM) value using a linear algorithm or a proportional-integral-derivative (PID) algorithm, and then, based on the PWM value, the fan rotational speed is calculated and written to specific registers of the complex programmable logic device to control the fan rotational speed; and 3: fan light, which is indirectly controlled by the baseboard management controller through writing to the complex programmable logic device, where the baseboard management controller determines the presence state of the fan by reading the complex programmable logic device, if the fan is absent, the baseboard management controller writes to specific registers of the complex programmable logic device to turn off the fan light, if the fan is present, the baseboard management controller reads the fan rotational speed, if the rotational speed is higher than a certain rotational speed, the baseboard management controller writes to specific registers of the complex programmable logic device to make the fan light illuminate green, indicating the normal fan rotational speed, and if the rotational speed is lower than a certain rotational speed, the baseboard management controller writes to specific registers of the complex programmable logic device to make the fan light illuminate orange, indicating the abnormal fan rotational speed. The fan rotational speed is determined by the temperatures of the various devices on the server, and the temperatures of these devices may continuously change over time. Therefore, the baseboard management controller needs to write to the complex programmable logic device every second regarding the fan rotational speed to ensure that the fan rotational speed is real-time data.

After describing some functions of the fan board above, the following formally illustrates the process of determining the current pending setting state using the example of controlling the current pending setting state of the fan light on the fan board. The process includes two parts: the first part is a process of acquiring the fan state, and the second part involves determining the current pending setting state of the indicator according to the fan state.

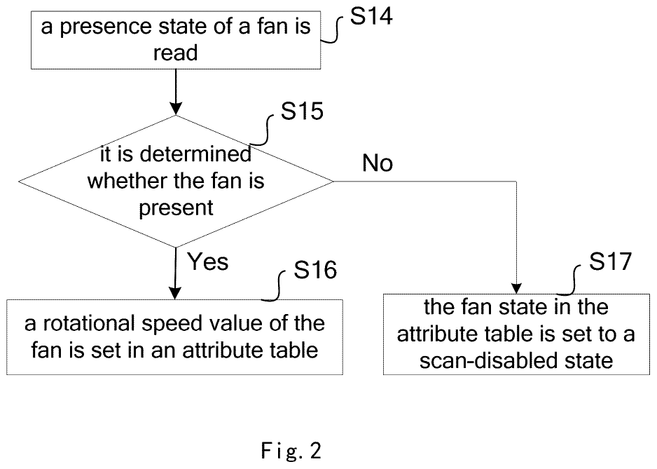

FIG. 2 is a flowchart of a method for acquiring a fan state according to an embodiment of this disclosure. As shown in FIG. 2, the method includes the following steps.

At S14, a presence state of a fan is read.

At S15, it is determined whether the fan is present; if yes, proceed to step S16; and if not, proceed to step S17.

At S16, a rotational speed value of the fan is set in an attribute table.

At S17, the fan state in the attribute table is set to a scan-disabled state.

During implementation, to acquire the fan state, specifically, 1, a baseboard management controller reads fan presence-related registers through an integrated circuit bus and address where a complex programmable logic device on a fan board is located;
2, whether the fan is present is determined according to values of the relevant registers, where if the fan is not present, the fan state in the attribute table is set to the scan-disabled state; and
3, if the fan is present, the fan rotational speed-related registers are continuously read to acquire a fan rotational speed, and the rotational speed is stored in the attribute table.

After the fan state is acquired, the current pending setting state (LEDPattern) of the indicator is determined according to the fan state. If the fan is not present, the current pending setting state of the fan light is determined to be a first state, which means the fan light is off (LEDPattern may be set to 0x00); if the fan is present and detected rotational speed value of the fan is greater than or equal to a threshold (e.g., 500 rpm), it indicates that the fan is normal, and the current pending setting state of the fan light is determined to be a second state (i.e., a normal state, with LEDPattern set to 0x01, representing a green light); and if the fan is present and the detected rotational speed value of the fan is less than the threshold (e.g., 500 rpm), it indicates that the fan rotational speed is too low, and the current pending setting state of the fan light is determined to be a third state (i.e., an abnormal state, with LEDPattern set to 0x10, representing an orange light).

As business requirements evolve, the functions of the complex programmable logic device may be added or modified. In this case, the complex programmable logic device on the board needs to be updated, such that a new complex programmable logic device mirror image takes effect. However, after the update of the complex programmable logic device, values in all register lists within the complex programmable logic device revert to default values. Functions indirectly controlled by the baseboard management controller writing to the complex programmable logic device also revert to default states. For example, the fan light reverts to a default state-off. In this case, the user may mistakenly determine or be unable to determine an operating state of devices according to a state of an indicating apparatus. Therefore, in this embodiment of this disclosure, after determining that the update of the complex programmable logic device on a target board is complete, the complex programmable logic device is rewritten to maintain a previous state of the indicating apparatus.

The update of the complex programmable logic device includes two steps: upgrading and refreshing. In the first step, upgrading involves the baseboard management controller writing an upgrade file of the complex programmable logic device to the complex programmable logic device through an integrated circuit bus channel. However, in this case, the complex programmable logic device does not take effect immediately. The second step of refreshing needs to be performed, and refreshing involves the baseboard management controller writing a command to the complex programmable logic device through the integrated circuit bus channel, and through the command, the upgrade file of the new complex programmable logic device may be caused to take effect. If the complex programmable logic device is refreshed to make the new complex programmable logic device file take effect while an operating system (OS) of the server is running, functions of a basic input/output system (BIOS) and the operating system may be influenced. Some data that needs to be acquired from the complex programmable logic device by the basic input/output system and then transmitted to the baseboard management controller may fail to be transmitted to the baseboard management controller. Moreover, after refreshing the complex programmable logic device, values in all the registers of the complex programmable logic device revert to default values. If the value in a particular register, which controls the power-on of the motherboard, changes to the default value, the motherboard is caused to lose power, leading to the shutdown of the operating system. If certain businesses are still ongoing in the operating system at this time, functions may be influenced. Therefore, the complex programmable logic device is always refreshed during shutdown. In practice, the server may be in a power-on state or a power-off state. The following is a description of a method for updating the complex programmable logic device on the target board when the server is in the power-off state and a method for updating the complex programmable logic device on the target board when the server is in the power-on state. In some embodiments, updating the complex programmable logic device on the target board includes the following steps.
an image file of the upgraded complex programmable logic device on the target board is acquired;
the image file of the upgraded complex programmable logic device on the target board is written into the complex programmable logic device on the target board;
the complex programmable logic device on the motherboard is accessed to acquire a power state of the server; and
a refresh operation on the complex programmable logic device on the target board is performed if detecting that the power state of the server is the power-off state.

To facilitate the user in understanding an update progress of the complex programmable logic device, a refresh variable is set in this embodiment of this disclosure. Specifically, before the updating the complex programmable logic device on the target board, the method further includes:
the refresh variable representing a refresh state is set to a first preset value and the first preset value is stored in the attribute table.

Before the performing a refresh operation on the complex programmable logic device on the target board if detecting that the power state of the server is the power-off state, the method further includes the following steps.
the refresh variable is set to a second preset value and storing the second preset value in the attribute table.

After detecting that the refresh operation on the complex programmable logic device on the target board is complete, the method further includes:
the refresh variable is set to a third preset value and storing the third preset value in the attribute table, where the first preset value, the second preset value, and the third preset value are all different.

In a case of detecting that the power state of the server is the power-on state, at least the integrated circuit bus and address where the complex programmable logic device on the target board is located, as well as a flag bit representing that the complex programmable logic device on the target board is not refreshed, are stored in a memory of the motherboard. The refresh operation on the complex programmable logic device on the target board is performed after a power cycle (power off, wait for a few seconds, and then power on). Performing the refresh operation on the complex programmable logic device on the target board after the power cycle includes the following steps.
after the power cycle, a fourth preset value is written to the memory in the complex programmable logic device of the motherboard that is configured to store the power state to control the server to power off, where the fourth preset value is not limited and is determined according to actual situations;
data in the memory of the motherboard is read and it is determined whether the data in the memory of the motherboard contains a flag bit representing that the complex programmable logic device on the target board is not refreshed; and
if yes, the refresh operation is performed on the complex programmable logic device on the target board according to the integrated circuit bus and address where the complex programmable logic device on the target board is located and that are in the memory of the motherboard.

Similarly, to facilitate the user in understanding the update progress of the complex programmable logic device, a refresh variable is set in this embodiment of this disclosure. Specifically, before the updating the complex programmable logic device on the target board, the method further includes the following steps.
the refresh variable representing a refresh state is set to a first preset value and the first preset value is stored in the attribute table.

After detecting that the data in the memory of the motherboard contains a flag bit representing that the complex programmable logic device on the target board is not refreshed and before performing the refresh operation on the complex programmable logic device on the target board according to the integrated circuit bus and address where the complex programmable logic device on the target board is located and that are in the memory of the motherboard, the method further includes the following steps.

The refresh variable is set to a second preset value and the second preset value is stored in the attribute table.

In a case of performing the refresh operation on the complex programmable logic device on the target board according to the integrated circuit bus and address where the complex programmable logic device on the target board is located and that are in the memory of the motherboard, the method further includes the following steps.

The refresh variable is set to a third preset value and the third preset value is stored in the attribute table, where the first preset value, the second preset value, and the third preset value are all different.

For the method for updating the complex programmable logic device when the server is in the power-off state and the method for updating the complex programmable logic device when the server is in the power-on state mentioned above, in a case of detecting that a current refresh state and a previous refresh state meet preset requirements, determining that the update of the complex programmable logic device on the target board is complete includes the following steps.

It is determined that the update of the complex programmable logic device on the target board is complete in a case of detecting that the refresh variable corresponding to the previous refresh state is the first preset value or the second preset value, and the refresh variable corresponding to the current refresh state is the third preset value.

The first preset value, the second preset value, and the third preset value for the refresh variable are not limited. For example, an initial value of 0 is set to indicate that no refresh is currently in progress, 1 indicates that a refresh is in progress, and 2 indicates that the refresh is complete.

Since the complex programmable logic device is only refreshed during shutdown, to ensure the normal operation of the server after the refresh is complete, during implementation, in a case of detecting that the data in the memory of the motherboard does not contain the flag bit representing that the complex programmable logic device on the target board is not refreshed, or performing the refresh operation on the complex programmable logic device on the target board according to the integrated circuit bus and address where the complex programmable logic device on the target board is located and that are in the memory of the motherboard, a fifth preset value is written to the memory that is configured to store the power state to control the server to power on. The fifth preset duration is not limited, which is determined according to actual situations.

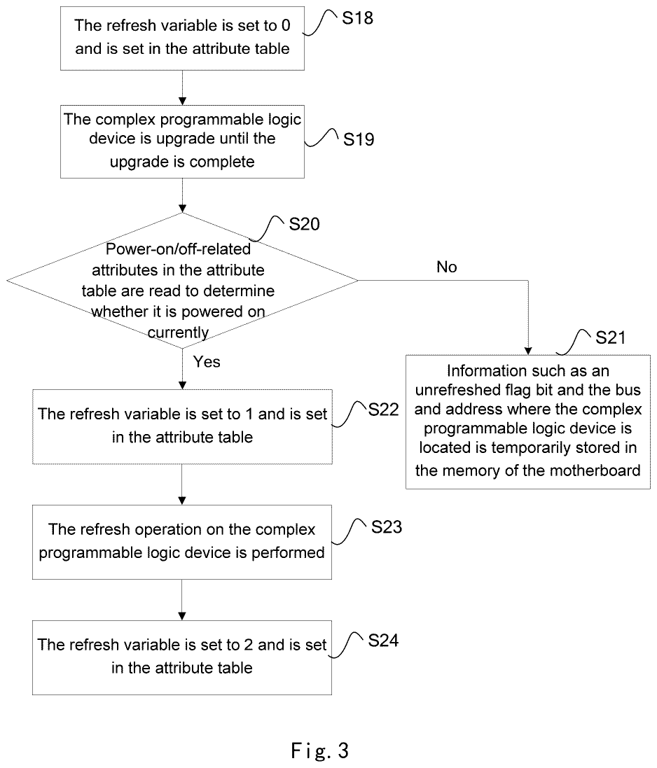

To facilitate the user in further understanding the update process of the complex programmable logic device, FIG. 3 is a flowchart of a method for updating a complex programmable logic device according to an embodiment of this disclosure. As shown in FIG. 3, the method includes the following steps.

At S18, The refresh variable is set to 0 and is set in the attribute table.

At S19, The complex programmable logic device is upgrade until the upgrade is complete.

At S20, Power-on/off-related attributes in the attribute table are read to determine whether it is powered on currently, where if not, proceed to step S21, and if yes, proceed to step S22.

At S21, Information such as an unrefreshed flag bit and the bus and address where the complex programmable logic device is located is temporarily stored in the memory of the motherboard.

At S22, The refresh variable is set to 1 and is set in the attribute table.

At S23, The refresh operation on the complex programmable logic device is performed.

At S24, The refresh variable is set to 2 and is set in the attribute table.

During implementation, updating the complex programmable logic device includes the following processes:
1. Before the update of the complex programmable logic device, the refresh variable is first set to 0 to indicate that a refresh phase is not reached at this time, and is set in the attribute table.
2. The complex programmable logic device image file is upgraded through a script, a web interface, redfish, or other methods, the baseboard management controller segments the image file into fixed sizes and writes the image file to the complex programmable logic device on the fan board through the integrated circuit bus channel, and in this case, the new complex programmable logic device mirror image does not take effect and requires a second refresh operation to take effect.
3. The power-on/off-related attributes in the attribute table are read to determine whether it is powered on or off currently, where if powered off, the operation of refreshing the complex programmable logic device and step 4 are performed, and if not, step 5 is performed.
4. If powered off, the refresh variable is first set to 1 and then written into the attribute table to indicate that the complex programmable logic device is currently refreshed, then, the baseboard management controller writes a preset value to a specific register in the complex programmable logic device to refresh the complex programmable logic device, after the refresh, the new complex programmable logic device mirror image takes effect, and then the refresh variable is to 2 and set in the attribute table to indicate that the refresh is complete.
5. If powered on, the refresh operation on the complex programmable logic device cannot be performed at this time, relevant information, such as the unrefreshed flag bit, and the integrated circuit bus and address where the fan board is located, is temporarily stored in an electrically erasable programmable read only memory (EEPROM) of the motherboard, and the refresh operation is performed during the next power cycle.

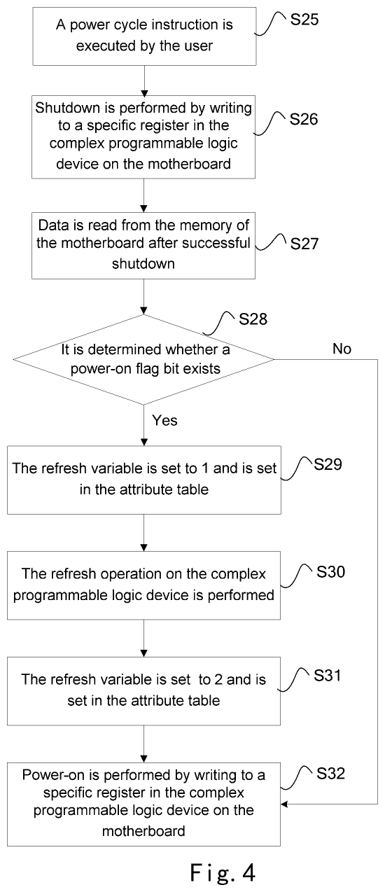

FIG. 4 is a flowchart of a method for refreshing a complex programmable logic device during a power cycle according to an embodiment of this disclosure. As shown in FIG. 4, the method includes the following steps.

At S25, A power cycle instruction is executed by the user.

At S26, Shutdown is performed by writing to a specific register in the complex programmable logic device on the motherboard.

At S27, Data is read from the memory of the motherboard after successful shutdown.

At S28, It is determined whether a power-on flag bit exists, where if yes, proceed to step S29, and if not, proceed to step S32.

At S29, The refresh variable is set to 1 and is set in the attribute table.

At S30, The refresh operation on the complex programmable logic device is performed.

At S31, The refresh variable is set to 2 and is set in the attribute table.

At S32, Power-on is performed by writing to a specific register in the complex programmable logic device on the motherboard.

During implementation, the method for refreshing the complex programmable logic device during the power cycle includes the following processes.
1. When the user executes the power cycle through a command, the web interface, or other methods, the baseboard management controller first indirectly controls the server to power off by writing a specific value to a specific register in the complex programmable logic device on the motherboard.
2. After shutdown, the refresh operation on the complex programmable logic device may be performed, and the data in the electrically erasable programmable read only memory of the motherboard is first read to determine whether the unrefreshed flag bit exists in the electrically erasable programmable read only memory, where if yes, it indicates that no update operation on the complex programmable logic device is performed while the server is powered on, and power-on is directly performed by writing to a specific register in the complex programmable logic device.
3. If the unrefreshed flag bit exists, it indicates that the server update operation is performed while the server is powered on, information such as the integrated circuit bus and address where the fan board is located is read from the electrically erasable programmable read only memory of the motherboard, the refresh variable is first set to 1 and set in the attribute table, then, the complex programmable logic device is refreshed, the refresh variable is then set to 2 and set in the attribute table, and finally power-on is performed.

To determine that the update of the complex programmable logic device on the target board is complete, in this embodiment of this disclosure, by acquiring the current refresh state and the previous refresh state prior to the current time of the complex programmable logic device on the target board, in a case of detecting that the current refresh state and the previous refresh state meet the preset requirements, determining that the update of the complex programmable logic device on the target board is complete. The preset requirements are not limited, which are determined according to actual situations. As described above, if the refresh variable corresponding to the current refresh state is 2, and the refresh variable corresponding to the previous refresh state prior to the current time is 0 or 1, it is determined that the update of the complex programmable logic device on the target board is complete.

During implementation, after determining that the update of the complex programmable logic device is complete, the complex programmable logic device may be written through the following methods.

Method 1: After the update of the complex programmable logic device is complete, the baseboard management controller is restarted, and the baseboard management controller may rewrite the complex programmable logic device once after being restarted, and the indicating apparatus remains in an original state.

Method 2: Regardless of whether the complex programmable logic device is updated, writing to the complex programmable logic device is performed once every second, thereby ensuring that even after the complex programmable logic device is updated, the indicating apparatus can remain in the original state.

However, in Method 1, a restart of the baseboard management controller is required. If the baseboard management controller is in the progress of performing other business operations, functions of the baseboard management controller are influenced. The method results in strong coupling between the complex programmable logic device and the baseboard management controller, which does not conform to the principle of high cohesion and low coupling.

In Method 2, writing to the complex programmable logic device every second significantly wastes resources of the central processing unit and the internal memory, leading to a high central processing unit occupancy rate and an internal memory usage rate. Moreover, since the baseboard management controller writes to the complex programmable logic device to control the state of the fan light through the integrated circuit bus, it represents a software-controlled hardware operation. If the integrated circuit bus becomes unresponsive, the process of the baseboard management controller writing to the complex programmable logic device through the integrated circuit bus may take a long time to complete. Writing every second means that each operation takes a long time to finish, potentially affecting other functions of a software system.

Therefore, to solve the problem of the impact on businesses of the baseboard management controller caused by the restart of the baseboard management controller after refreshing the complex programmable logic device, as well as to reduce the frequency of writing to the complex programmable logic device and avoid wasting the resources of the central processing unit and the internal memory, in this embodiment of this disclosure, after determining that the update of the complex programmable logic device is complete, in a case of the baseboard management controller being operational, the data correspondingly representing the current pending setting state is written to the complex programmable logic device on the target board, thereby allowing the complex programmable logic device on the target board to control the state of the indicating apparatus to the current pending setting state.

According to the method provided in this embodiment of this disclosure, firstly, after determining that the update of the complex programmable logic device on the target board is complete, the baseboard management controller writes the data correspondingly representing the current pending setting state to the complex programmable logic device on the target board, such that after the update of the complex programmable logic device is complete, the indicating apparatus can still maintain the pending setting state before the update of the complex programmable logic device, instead of a default state, thereby allowing the indicating apparatus to accurately reflect the operating state of the device and the user to accurately understand the operating state of the device through the indicating apparatus. Secondly, since the baseboard management controller writes the data correspondingly representing the current pending setting state to the complex programmable logic device on the target board when being operational, compared to the method of restarting the baseboard management controller to write to the complex programmable logic device, the method provided in this disclosure ensures the operation of other businesses on the baseboard management controller. Thirdly, compared to the method of writing to the complex programmable logic device every second regardless of whether the complex programmable logic device is updated, according to the method provided in this disclosure, writing to the complex programmable logic device is only performed after determining that the update of the complex programmable logic device is complete, thereby reducing the frequency of writing to the complex programmable logic device and avoiding wasting the resources of the central processing unit and the internal memory, and also avoiding potential impacts on software performance due to faults of hardware such as an integrated circuit bus line, and improving the user experience when using the server. Additionally, in this method, by detecting that the current refresh state and the previous refresh state meet the preset requirements to determine that the update of the complex programmable logic device on the target board is complete, the accurate determination of the completion of the update of the complex programmable logic device is achieved, and the timing for writing to the complex programmable logic device is more accurate.

In practice, the operating state of the device typically remains unchanged over a period of time. If the operating state of the indicating apparatus is updated by writing to the complex programmable logic device every second, a waste of the resources of the central processing unit and the internal memory may be caused. Therefore, to reduce resource wastage, in some embodiments, after writing the data correspondingly representing the current pending setting state to the complex programmable logic device on the target board, the method further includes: the step of acquiring the current pending setting state of the indicating apparatus corresponding to the target device is returned to obtain a new current pending setting state;
it is determined whether the current pending setting state is the same as the new current pending setting state;
if yes, the data correspondingly representing the current pending setting state of the complex programmable logic device on the target board is maintained unchanged; and
if not, data correspondingly representing the new current pending setting state is written to the complex programmable logic device on the target board, so as to control the state of the indicating apparatus to be updated from the current pending setting state to the new current pending setting state through the complex programmable logic device on the target board.

The fan light is still used as an example to illustrate the current pending setting state of the fan light. Compared to the new current pending setting state (represented by LEDPattern), the previous current pending setting state is a previously set state (represented by PreLEDPattern). If PreLEDPattern is different from LEDPattern, it indicates that the fan state changes, and the fan light state needs to be updated in this case. That is, in this case, the data correspondingly representing the new current pending setting state is written to the complex programmable logic device on the target board, thereby controlling the state of the indicating apparatus to be updated from the current pending setting state to the new current pending setting state through the complex programmable logic device on the target board.

In the method provided by this embodiment, writing to the complex programmable logic device is performed only when it is detected that the current pending setting state is different from the new current pending setting state. Compared to the method of updating the operating state of the indicating apparatus by writing to the complex programmable logic device every second, the method provided by this embodiment reduces resource wastage.

There are a plurality of devices on the server, and the operating state of the plurality of devices is likely to be displayed through states of corresponding indicating apparatuses. To ensure that the operating state of the plurality of devices is reflected as accurately as possible through the corresponding indicating apparatuses, in some embodiments, before acquiring the current pending setting state of the indicating apparatus corresponding to the target device, the method further includes the following steps.
information about all target devices is acquired and the information about the target devices is stored in the attribute table, where the information about the target devices includes at least the quantity of all the target devices and identifiers of the target devices.

Acquiring the current pending setting state of the indicating apparatus corresponding to the target device includes the following steps.
a current pending setting state of the indicating apparatus corresponding to each target device is acquired from the attribute table.

By recording all devices in the attribute table and performing the steps of the forgoing method for controlling an indicating apparatus for each device, after the update of the complex programmable logic device is complete, the indicating apparatus corresponding to each device can still accurately reflect the operating state of the device, thereby improving the user experience when using the server.

To allow those skilled in the art to better understand the solution of this disclosure, the control process of the fan light is used as an example to further describe this disclosure in conjunction with the accompanying drawings and specific implementations below. A specific lighting process is divided into the following modules: 1, a fan state acquiring module; 2, a complex programmable logic device update module; 3, a power cycle refresh module; and 4, a lighting module. A control process of the fan state acquiring module (refer to FIG. 2), a control process of the complex programmable logic device update module (refer to FIG. 3), and a control process of the power cycle refresh module (refer to FIG. 4) have been described in detail above and will not be repeated here. Only the control process of the lighting module is described.

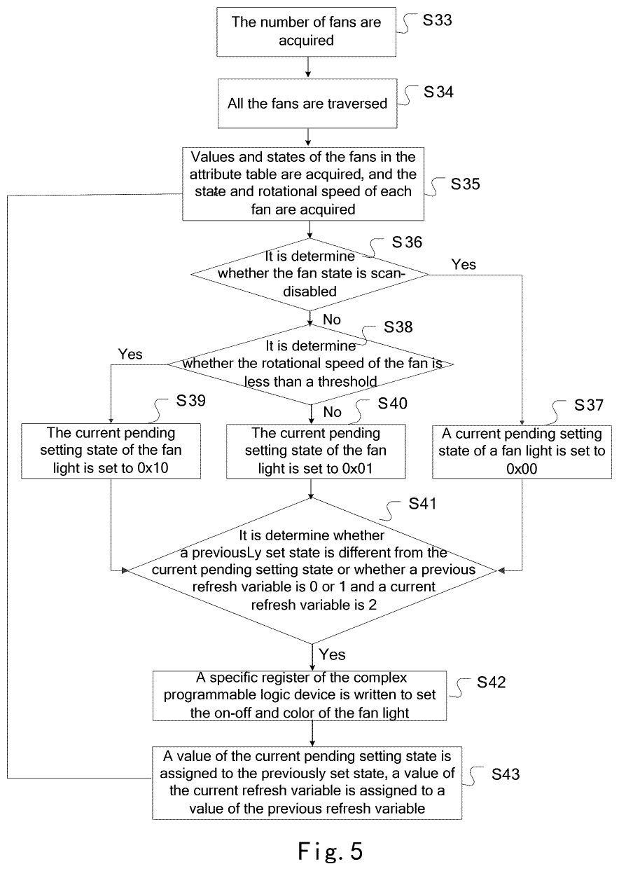

FIG. 5 is a flowchart of a method for controlling a lighting module according to an embodiment of this disclosure. As shown in FIG. 5, the method includes the following steps.

At S33, The number of fans are acquired.

At S34, All the fans are traversed.

At S35, Values and states of the fans in the attribute table are acquired, and the state and rotational speed of each fan are acquired.

At S36, It is determine whether the fan state is scan-disabled, where if yes, proceed to step S37, and if not, proceed to step S38.

At S37, A current pending setting state of a fan light is set to 0x00.

At S38, It is determine whether the rotational speed of the fan is less than a threshold, where if yes, proceed to step S39, and if not, proceed to step S40.

At S39, The current pending setting state of the fan light is set to 0x10.

At S40, The current pending setting state of the fan light is set to 0x01.

At S41, It is determine whether a previously set state is different from the current pending setting state or whether a previous refresh variable is 0 or 1 and a current refresh variable is 2, where if yes, proceed to step S42.

At S42, A specific register of the complex programmable logic device is written to set the on-off and color of the fan light.

At S43, A value of the current pending setting state is assigned to the previously set state, a value of the current refresh variable is assigned to a value of the previous refresh variable, and return to step S35.

It should be noted that for step S41, if not, a value of the specific register of the complex programmable logic device remains unchanged.

During implementation, the method for controlling the lighting module specifically includes the following processes the following steps.
1. The number of fans that should be present on the current server are obtained by reading the attribute table, and traverse each fan to perform subsequent operations on each fan.
2. The rotational speed value and state of each fan are read from the attribute table, it is determined whether the fan state is scan-disabled, and if it is scan-disabled, indicating that the fan is not currently plugged in, the current pending setting state LEDPattern of the fan light is set to 0x00, namely, an off state.
3. If the fan state is not the scan-disabled state, indicating that the fan is plugged in, continue to determine whether the rotational speed value of the fan is less than a certain threshold, such as 500 rpm, where if yes, the fan rotational speed is too low, a fault may occur, and the current pending setting state LEDPattern of the fan light is set to 0x10, namely, an orange light.
4. If the fan rotational speed is not lower than the threshold, indicating that it is normal, the current pending setting state LEDPattern of the fan light is set to 0x01, namely, a green light.
5. It is determined whether “PreLEDPattern (representing the previous state set for the fan light, with a default value of 0xff) is different from LEDPattern (representing the current pending setting state of the fan light, with 0x00 indicating off, 0x01 indicating the green light, 0x10 indicating the orange light, and 0xff being the default value when the baseboard management controller starts up)” or “PreRefresh (representing a previous refresh state of the complex programmable logic device) is 0 or 1 and refresh (representing a current refresh state of the complex programmable logic device) is 2”. If the PreLEDPattern value is different from the LEDPattern value, it indicates that the fan state changes, and the fan light state needs to be updated. If PreRefresh is 0 or 1 and refresh is 2, it indicates that the update of the complex programmable logic device is just compete, the fan light changes to the default state-off, and the fan light state needs to be updated again.
6. The baseboard management controller writes the value of LEDPattern to a specific register of the complex programmable logic device on a fan board, and the complex programmable logic device controls the on/off of the fan light.
7. Finally, the value of LEDPattern is assigned to PreLEDPattern, a value of refresh is assigned to PreRefresh, and continue to a next cycle.

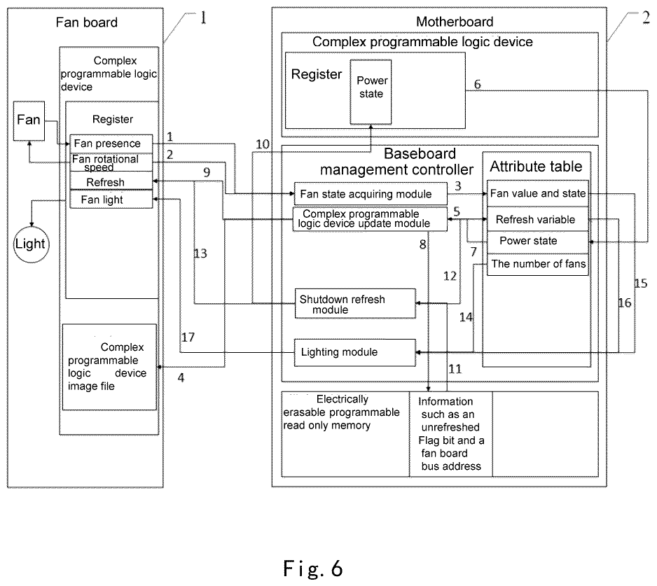

Further, FIG. 6 is an architectural diagram of the maintenance of a fan light state after updating a complex programmable logic device on a fan board according to an embodiment of this disclosure. As shown in FIG. 6, the architecture includes a fan board 1 and a motherboard 2, and data interaction is performed between the fan board 1 and the motherboard 2 to maintain the fan light state after updating the complex programmable logic device on the fan board. A direction of arrows in FIG. 6 is defined based on the fan state acquiring module, the complex programmable logic device update module, the power cycle refresh module, and the lighting module, data flowing into these four modules indicates read, and data flowing out indicates write.

The method for maintaining the fan light state after updating the complex programmable logic device on the fan board, implemented through the foregoing architecture, specifically includes the following processes.
1. The fan state acquiring module reads a fan presence from a register list of the complex programmable logic device on the fan board.
2. The fan state acquiring module reads a fan rotational speed from the register list of the complex programmable logic device on the fan board.
3. The fan state acquiring module writes the state and the rotational speed of a fan to the attribute table of the baseboard management controller.
4. The complex programmable logic device update module upgrades a complex programmable logic device mirror image to the complex programmable logic device on the fan board.
5. The complex programmable logic device update module writes a value of a refresh variable to the attribute table of the baseboard management controller.
6. The baseboard management controller reads the complex programmable logic device on the motherboard to acquire a power state of the server and writes the power state into the attribute table of the baseboard management controller.
7. The complex programmable logic device update module reads the attribute table to acquire the power state.
8. The complex programmable logic device update module writes information such as an unrefreshed flag bit and a bus address to the EEPROM on the motherboard.
9. The complex programmable logic device update module writes to a register of the complex programmable logic device on the fan board to refresh the complex programmable logic device.
10. A shutdown refresh module shuts down the server by writing to the register of the complex programmable logic device on the motherboard.
11. The shutdown refresh module reads a memory on the motherboard (specifically referring to the electrically erasable programmable read only memory) to acquire information such as the unrefreshed flag bit and a fan board bus address.
12. The shutdown refresh module writes the value of the refresh variable to the attribute table of the baseboard management controller.
13. The shutdown refresh module writes to the register of the complex programmable logic device on the fan board to refresh the complex programmable logic device.
14. The lighting module reads the attribute table of the baseboard management controller to acquire the number of fans.
15. The lighting module reads the attribute table of the baseboard management controller to acquire the rotational speed and the state of the fan.
16. The lighting module reads the attribute table of the baseboard management controller to acquire the value of the refresh variable.
17. The lighting module writes to the register of the complex programmable logic device on the fan board.

In the method provided in this embodiment, by determining whether the refresh of the complex programmable logic device on the fan board is complete, if the refresh is complete, writing to the complex programmable logic device is performed again to relight the light. The method solves the problem that the fan indicator fails to illuminate due to the inability of the baseboard management controller to detect changes in the fan state after the refresh of the complex programmable logic device is complete. The method eliminates the need to restart the baseboard management controller after the refresh of the complex programmable logic device, thereby avoiding the impact on the businesses of the baseboard management controller. This method simply involves rewriting to the register corresponding to the fan indicator in the complex programmable logic device once after the refresh of the complex programmable logic device is complete, rather than writing to it every second, thereby avoiding wastage of the resources of the central processing unit and the internal memory, while also avoiding potential impacts on software performance due to faults of hardware such as the integrated circuit bus line. Further, this method is compatible whether the complex programmable logic device update is performed during shutdown or power-on.

It should be noted that the method provided in this embodiment is specific to the problem of the fan indicator failing to illuminate after the refresh of the complex programmable logic device on the fan board, but is not only limited to this problem. For example, the solution is also applicable to other boards such as hard disk backplanes, motherboards, and input/output boards, which may have indicators or components with only a few states (not necessarily indicators) that require state updates through the baseboard management controller writing to the complex programmable logic device only after a state change occurs.

According to the foregoing embodiments, the method for controlling an indicating apparatus is described in detail. This disclosure further provides embodiments corresponding to an apparatus for controlling an indicating apparatus, and a server. It should be noted that the embodiments of the apparatus part in this disclosure are described from two perspectives: one based on functional modules and the other based on hardware.

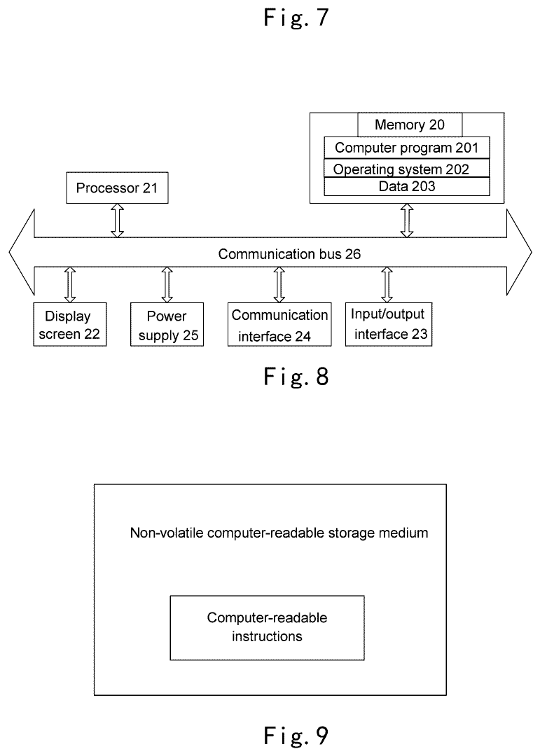

FIG. 7 is a structural diagram of an apparatus for controlling an indicating apparatus according to an embodiment of this disclosure. This embodiment, based on the perspective of the functional modules, includes:
a first acquiring module 10, configured to acquire a current pending setting state of the indicating apparatus corresponding to a target device;
a second acquiring module 11, configured to acquire a current refresh state and a previous refresh state prior to the current time of a complex programmable logic device on a target board, where the refresh state includes an unrefreshed state, a refreshing state, and a refresh-completed state; and the target board is a board to which the indicating apparatus is connected, and the target device is a device arranged on the target board;
a detection and determination module 12, configured to determine, in a case of detecting that the current refresh state and the previous refresh state meet preset requirements, that the update of the complex programmable logic device on the target board is complete; and
a writing module 13, configured to write, in a case of a baseboard management controller being operational, data correspondingly representing the current pending setting state into the complex programmable logic device on the target board, so as to control a state of the indicating apparatus to the current pending setting state through the complex programmable logic device on the target board.

In some embodiments, the apparatus for controlling an indicating apparatus further includes: a first judgment module, configured to determine whether the current pending setting state is the same as a new current pending setting state, if yes, trigger a holding module, and if not, trigger a first writing module;
the holding module, configured to maintain the data correspondingly representing the current pending setting state of the complex programmable logic device on the target board unchanged; and
the first writing module, configured to write data correspondingly representing the new current pending setting state to the complex programmable logic device on the target board, so as to control the state of the indicating apparatus to be updated from the current pending setting state to the new current pending setting state through the complex programmable logic device on the target board.

The first acquiring module 10 specifically includes:
a third acquiring module, configured to acquire a presence state of the target device;
a first determination module, configured to determine, in a case of detecting that the target device is not present, the current pending setting state of the indicating apparatus corresponding to the target device as a first state;
a fourth acquiring module, configured to acquire, in a case of detecting that the target device is present, an attribute value of the target device, where an attribute of the target device is determined according to a type of the target device;
a second determination module, configured to determine the current pending setting state of the indicating apparatus corresponding to the target device as a second state if it is detected that the attribute value is greater than or equal to a threshold; and
a third determination module, configured to determine the current pending setting state of the indicating apparatus corresponding to the target device as a third state if it is detected that the attribute value is less than the threshold.

In some embodiments, the third acquiring module specifically includes:
a first reading module, configured to read a register for storing presence state data of the target device through an integrated circuit bus and address where the complex programmable logic device on the target board is located;
a first storage module, configured to store the presence state data of the target device read from the register for storing the presence state data of the target device in an attribute table; and
a fifth acquiring module, configured to acquire a presence state of the target device from the attribute table.

In some embodiments, the fourth acquiring module specifically includes:
a second reading module, configured to read a register for storing the attribute value of the target device through the integrated circuit bus and address where the complex programmable logic device on the target board is located;
a second storage module, configured to store the attribute value of the target device read from the register for storing the attribute value of the target device in the attribute table; and
a sixth acquiring module, configured to acquire the attribute value of the target device from the attribute table.

In some embodiments, the apparatus for controlling an indicating apparatus includes an update module, configured to update the complex programmable logic device on the target board.

The update module specifically includes:
a seventh acquiring module, configured to acquire a image file of the upgraded complex programmable logic device on the target board;
a second writing module, configured to write the image file of the upgraded complex programmable logic device on the target board into the complex programmable logic device on the target board;
an eighth acquiring module, configured to access the complex programmable logic device on a motherboard to acquire a power state of a server; and
a first refresh module, configured to perform a refresh operation on the complex programmable logic device on the target board if detecting that the power state of the server is a power-off state.

In some embodiments, the apparatus for controlling an indicating apparatus further includes:
a second refresh module, configured to store, in a case of detecting that the power state of the server is a power-on state, at least the integrated circuit bus and address where the complex programmable logic device on the target board is located, as well as a flag bit representing that the complex programmable logic device on the target board is not refreshed, in a memory of the motherboard, and perform the refresh operation on the complex programmable logic device on the target board after a power cycle.

In some embodiments, the apparatus for controlling an indicating apparatus further includes:
a third storage module, configured to set a refresh variable representing a refresh state to a first preset value and store the first preset value in the attribute table;
a fourth storage module, configured to set the refresh variable to a second preset value and store the second preset value in the attribute table; and
a fifth storage module, configured to set the refresh variable to a third preset value and store the third preset value in the attribute table, where the first preset value, the second preset value, and the third preset value are all different.

In some embodiments, the second refresh module specifically includes:
a third writing module, configured to write a fourth preset value to the memory in the complex programmable logic device of the motherboard that is configured to store the power state to control the server to power off after the power cycle;
a second judgment module, configured to read data in the memory of the motherboard and determine whether the data in the memory of the motherboard contains a flag bit representing that the complex programmable logic device on the target board is not refreshed; and if yes, trigger a third refresh module; and
the third refresh module, configured to perform the refresh operation on the complex programmable logic device on the target board according to the integrated circuit bus and address where the complex programmable logic device on the target board is located and that are in the memory of the motherboard.

In some embodiments, the apparatus for controlling an indicating apparatus further includes:
a sixth storage module, configured to set a refresh variable representing a refresh state to a first preset value and store the first preset value in the attribute table;
a seventh storage module, configured to set the refresh variable to a second preset value and store the second preset value in the attribute table; and
an eighth storage module, configured to set the refresh variable to a third preset value and store the third preset value in the attribute table, where the first preset value, the second preset value, and the third preset value are all different.

In some embodiments, the apparatus for controlling an indicating apparatus further includes:
a fourth writing module, configured to write a fifth preset value to the memory that is configured to store the power state to control the server to power on in a case of detecting that the data in the memory of the motherboard does not contain the flag bit representing that the complex programmable logic device on the target board is not refreshed, or performing the refresh operation on the complex programmable logic device on the target board according to the integrated circuit bus and address where the complex programmable logic device on the target board is located and that are in the memory of the motherboard.

The detection and determination module 12 is specifically configured to determine that the update of the complex programmable logic device on the target board is complete in a case that the refresh variable corresponding to the previous refresh state is the first preset value or the second preset value, and the refresh variable corresponding to the current refresh state is the third preset value.

In some embodiments, the apparatus for controlling an indicating apparatus further includes:
an acquiring and storing module, configured to acquire information about all target devices and store the information about the target devices in the attribute table, where the information about the target devices includes at least the quantity of all the target devices and identifiers of the target devices.

The first acquiring module 10 is specifically configured to acquire a current pending setting state of the indicating apparatus corresponding to each target device from the attribute table.

Since the embodiments of the apparatus part correspond to those of the method part, please refer to the description of the embodiments of the method part on the embodiments of the apparatus part, which will not be repeated herein.

FIG. 8 is a structural diagram of a server according to another embodiment of this disclosure. In this embodiment, based on the hardware perspective, as shown in FIG. 8, the server includes:
a memory 20, configured to store computer-readable instructions; and
a processor 21, configured to execute the computer-readable instructions to implement the steps of the method for controlling an indicating apparatus mentioned in the foregoing embodiments.

The processor 21 may include one or more processing cores, such as a 4-core processor and an 8-core processor. The processor 21 may be implemented in at least one hardware form among a digital signal processor (DSP), a field-programmable gate array (FPGA), and a programmable logic array (PLA). The processor 21 may also include a main processor and a coprocessor. The main processor is a processor configured to process data in an awake state and is also known as a CPU. The coprocessor is a low-power-consumption processor configured to process data in a standby state. In some embodiments, the processor 21 may be integrated with a GPU. The GPU is configured to render and draw content that needs to be displayed on a display screen. In some embodiments, the processor 21 may also include an artificial intelligence (AI) processor configured to process computational operations related to machine learning.

The memory 20 may include one or more non-transitory computer-readable storage media, which may be non-transient. The memory 20 may further include a high-speed random access memory and a non-transitory memory, such as one or more disk storage devices or flash storage devices. In this embodiment, the memory 20 is at least configured to store following computer-readable instructions 201. After the computer-readable instructions are loaded and executed by the processor 21, the relevant steps of the method for controlling an indicating apparatus disclosed in any one of the foregoing embodiments can be implemented. Additionally, resources stored in the memory 20 may also include an operating system 202, data 203, etc., and a storage method may be temporary storage or permanent storage. The operating system 202 may include Windows, Unix, Linux, etc. The data 203 may include, but is not limited to, data related to the method for controlling an indicating apparatus mentioned above.

In some embodiments, the server may also include a display screen 22, an input/output interface 23, a communication interface 24, a power supply 25, and a communication bus 26.

Those skilled in the art should understand that the structure shown in FIG. 8 does not constitute a limitation on the server and may include more or fewer components than illustrated.

The server provided in this embodiment of this disclosure includes the memory and the processor. The processor, when executing a program stored in the memory, can implement the following method: the method for controlling an indicating apparatus, with the same effects as described above.

Finally, this disclosure further provides an embodiment corresponding to a non-transitory computer-readable storage medium, wherein computer-readable instructions are stored in the non-transitory computer-readable storage medium, and the computer-readable instructions are configured to cause, when executed by processor, the processor to perform the steps recorded in the foregoing method embodiments.

It should be understood that if the methods in the foregoing embodiments are implemented in the form of a software functional unit and sold or used as independent products, a computer-readable storage medium may be used for storage. Based on the understanding, the technical solutions of this disclosure essentially, or the part contributing to the prior art, or all or some of the technical solutions may be embodied in the form of a software product. The computer software product is stored in a storage medium to perform all or some of the steps of the method according to one or more embodiments of this disclosure. The foregoing storage medium includes various media that may store program code, such as a U disk, a mobile hard disk, a read-only memory (ROM), a random access memory (RAM), a magnetic disk, or an optical disk.

The non-transitory computer-readable storage medium provided by this disclosure includes the aforementioned method for controlling an indicating apparatus, with the same effects as described above.

The above provides a detailed introduction to the method and apparatus for controlling an indicating apparatus, the server, and the medium provided in this disclosure. The various embodiments in the specification are described in a progressive manner, with each embodiment highlighting the differences from other embodiments. The identical or similar parts between different embodiments may be cross-referenced to each other. The apparatus disclosed by the embodiment corresponds to the method disclosed by the embodiment, and therefore, the description is simple, and for associated parts, please refer to part of the description of the method. It should be noted that those of ordinary skill in the art may also make a plurality of improvements and modifications on this disclosure without departing from the principle of this disclosure, and these improvements and modifications shall fall within the scope of protection of this disclosure.

It should also be noted that in the specification, relational terms such as first and second are only used to distinguish one entity or operation from another entity or operation, and do not necessarily require or imply that such an actual relationship or order exists between these entities or operations. Moreover, the terms “include”, “contain”, or any other variants thereof are intended to cover a non-exclusive inclusion, such that a process, a method, an article, or a device that includes a series of elements not only includes those elements but also includes other elements that are not expressly listed, or further includes elements inherent to such process, method, article, or device. In the absence of more restrictions, an element defined by the phrase “including a/an.” does not exclude another identical element in a process, a method, an article, or a device that includes the element.

1. A method for controlling an indicating apparatus, performed by a baseboard management controller of a motherboard, comprising:
acquiring a current pending setting state of the indicating apparatus corresponding to a target device;
acquiring a current refresh state and a previous refresh state prior to the current time of a complex programmable logic device on a target board, wherein the refresh state comprises an unrefreshed state, a refreshing state, and a refresh-completed state; and the target board is a board to which the indicating apparatus is connected, and the target device is a device arranged on the target board;
determining, in a case of detecting that the current refresh state and the previous refresh state meet preset requirements, that the update of the complex programmable logic device on the target board is complete; and
writing, in a case of the baseboard management controller being operational, data correspondingly representing the current pending setting state into the complex programmable logic device on the target board, so as to control a state of the indicating apparatus to the current pending setting state through the complex programmable logic device on the target board.

2. The method for controlling an indicating apparatus according to claim 1, wherein after writing the data correspondingly representing the current pending setting state into the complex programmable logic device on the target board, the method further comprises:
returning to the step of acquiring the current pending setting state of the indicating apparatus corresponding to the target device to obtain a new current pending setting state;
determining whether the current pending setting state is the same as the new current pending setting state; and
in response to the current pending setting state being the same as the new current pending setting state, maintaining the data correspondingly representing the current pending setting state of the complex programmable logic device on the target board unchanged.

3. The method for controlling an indicating apparatus according to claim 2, the method further comprises:
in response to the current pending setting state being different from the new current pending setting state, writing data correspondingly representing the new current pending setting state into the complex programmable logic device on the target board, so as to control the state of the indicating apparatus to be updated from the current pending setting state to the new current pending setting state through the complex programmable logic device on the target board.

4. The method for controlling an indicating apparatus according to claim 3, wherein the acquiring a current pending setting state of the indicating apparatus corresponding to a target device comprises:
acquiring a presence state of the target device;
determining, in a case of detecting that the target device is not present, the current pending setting state of the indicating apparatus corresponding to the target device as a first state;
acquiring, in a case of detecting that the target device is present, an attribute value of the target device, wherein an attribute of the target device is determined according to a type of the target device; and
determining the current pending setting state of the indicating apparatus corresponding to the target device as a second state in response to detecting that the attribute value is greater than or equal to a threshold.

5. The method for controlling an indicating apparatus according to claim 4, the method further comprises:
determining the current pending setting state of the indicating apparatus corresponding to the target device as a third state in response to detecting that the attribute value is less than the threshold.

6. The method for controlling an indicating apparatus according to claim 4, wherein the acquiring a presence state of the target device comprises:
reading a register for storing presence state data of the target device through an integrated circuit bus and address where the complex programmable logic device on the target board is located;
storing the presence state data of the target device read from the register for storing the presence state data of the target device in an attribute table; and
acquiring a presence state of the target device from the attribute table.

7. The method for controlling an indicating apparatus according to claim 6, wherein the acquiring an attribute value of the target device comprises:
reading a register for storing the attribute value of the target device through the integrated circuit bus and address where the complex programmable logic device on the target board is located;
storing the attribute value of the target device read from the register for storing the attribute value of the target device in the attribute table; and
acquiring the attribute value of the target device from the attribute table.

8. The method for controlling an indicating apparatus according to claim 7, wherein updating the complex programmable logic device on the target board comprises:
acquiring a image file of the upgraded complex programmable logic device on the target board;
writing the image file of the upgraded complex programmable logic device on the target board into the complex programmable logic device on the target board;
accessing the complex programmable logic device on the motherboard to acquire a power state of a server; and
performing a refresh operation on the complex programmable logic device on the target board in a case of detecting that the power state of the server is a power-off state.

9. The method for controlling an indicating apparatus according to claim 8, the method further comprises:
upgrading the image file of the complex programmable logic device on the target board through a script, a web interface or redfish manner.

10. The method for controlling an indicating apparatus according to claim 9, wherein the writing the image file of the upgraded complex programmable logic device on the target board into the complex programmable logic device on the target board comprises:
after segmenting, by the baseboard management controller, the image file of the upgraded complex programmable logic device on the target board into fixed sizes, writing to the complex programmable logic device on the target board through an integrated circuit bus channel.

11. The method for controlling an indicating apparatus according to claim 8, the method further comprises:
storing, in a case of detecting that the power state of the server is a power-on state, at least the integrated circuit bus and address where the complex programmable logic device on the target board is located, as well as a flag bit representing that the complex programmable logic device on the target board is not refreshed, in a memory of the motherboard, and performing a refresh operation on the complex programmable logic device on the target board after a power cycle.

12. The method for controlling an indicating apparatus according to claim 8, wherein before updating the complex programmable logic device on the target board, the method further comprises:
setting a refresh variable representing a refresh state to a first preset value and storing the first preset value in the attribute table; after detecting that the power state of the server is the power-off state and before the performing a refresh operation on the complex programmable logic device on the target board, the method further comprises:
setting the refresh variable to a second preset value and storing the second preset value in the attribute table; and
after detecting that the refresh operation on the complex programmable logic device on the target board is complete, the method further comprises: setting the refresh variable to a third preset value and storing the third preset value in the attribute table, wherein the first preset value, the second preset value, and the third preset value are all different.

13. The method for controlling an indicating apparatus according to claim 11, wherein the performing a refresh operation on the complex programmable logic device on the target board after a power cycle comprises:
writing a fourth preset value to the memory in the complex programmable logic device of the motherboard that is configured to store the power state to control the server to power off after the power cycle;
reading data in the memory of the motherboard and determining whether the data in the memory of the motherboard contains a flag bit representing that the complex programmable logic device on the target board is not refreshed; and
in response to the data in the memory of the motherboard containing the flag bit representing that the complex programmable logic device on the target board is not refreshed, performing the refresh operation on the complex programmable logic device on the target board according to the integrated circuit bus and address where the complex programmable logic device on the target board is located and that are in the memory of the motherboard.

14. The method for controlling an indicating apparatus according to claim 13, wherein before updating the complex programmable logic device on the target board, the method further comprises:
setting a refresh variable representing a refresh state to a first preset value and storing the first preset value in the attribute table;
after detecting that the data in the memory of the motherboard contains the flag bit representing that the complex programmable logic device on the target board is not refreshed and before performing the refresh operation on the complex programmable logic device on the target board according to the integrated circuit bus and address where the complex programmable logic device on the target board is located and that are in the memory of the motherboard, the method further comprises:
setting the refresh variable to a second preset value and storing the second preset value in the attribute table; and
in a case of performing the refresh operation on the complex programmable logic device on the target board according to the integrated circuit bus and address where the complex programmable logic device on the target board is located and that are in the memory of the motherboard, the method further comprises:
setting the refresh variable to a third preset value and storing the third preset value in the attribute table, wherein the first preset value, the second preset value, and the third preset value are all different.

15. The method for controlling an indicating apparatus according to claim 13, the method further comprises:
writing, in a case of detecting that the data in the memory of the motherboard does not contain the flag bit representing that the complex programmable logic device on the target board is not refreshed, or performing the refresh operation on the complex programmable logic device on the target board according to the integrated circuit bus and address where the complex programmable logic device on the target board is located and that are in the memory of the motherboard, a fifth preset value to the memory that is configured to store the power state to control the server to power on.

16. The method for controlling an indicating apparatus according to claim 12, wherein the determining, in a case of detecting that the current refresh state and the previous refresh state meet preset requirements, that the update of the complex programmable logic device on the target board is complete comprises:
determining, in a case of detecting that the refresh variable corresponding to the previous refresh state is the first preset value or the second preset value, and the refresh variable corresponding to the current refresh state is the third preset value, that the update of the complex programmable logic device on the target board is complete.

17. The method for controlling an indicating apparatus according to claim 13, wherein before the acquiring a current pending setting state of the indicating apparatus corresponding to a target device, the method further comprises:
acquiring information of all target devices and storing the information of the target devices in the attribute table, wherein the information about the target devices at least comprises the quantity of all the target devices and an identifier of each target device; and
acquiring a current pending setting state of the indicating apparatus corresponding to the target device comprises:
acquiring a current pending setting state of the indicating apparatus corresponding to each target device from the attribute table.

18. (canceled)

19. A server, comprising:
a memory, configured to store computer-readable instructions; and
a processor, configured to execute the computer-readable instructions to:
acquire a current pending setting state of the indicating apparatus corresponding to a target device;
acquire a current refresh state and a previous refresh state prior to the current time of a complex programmable logic device on a target board, wherein the refresh state comprises an unrefreshed state, a refreshing state, and a refresh-completed state; and the target board is a board to which the indicating apparatus is connected, and the target device is a device arranged on the target board;
determine, in a case of detecting that the current refresh state and the previous refresh state meet preset requirements, that the update of the complex programmable logic device on the target board is complete; and
write, in a case of the baseboard management controller being operational, data correspondingly representing the current pending setting state into the complex programmable logic device on the target board, so as to control a state of the indicating apparatus to the current pending setting state through the complex programmable logic device on the target board.

20. A non-transitory computer-readable storage medium, wherein computer-readable instructions are stored in the non-transitory computer-readable storage medium, and the computer-readable instructions are configured to cause, when executed by processor, the processor to:
acquire a current pending setting state of the indicating apparatus corresponding to a target device;
acquire a current refresh state and a previous refresh state prior to the current time of a complex programmable logic device on a target board, wherein the refresh state comprises an unrefreshed state, a refreshing state, and a refresh-completed state; and the target board is a board to which the indicating apparatus is connected, and the target device is a device arranged on the target board;
determine, in a case of detecting that the current refresh state and the previous refresh state meet preset requirements, that the update of the complex programmable logic device on the target board is complete; and
write, in a case of the baseboard management controller being operational, data correspondingly representing the current pending setting state into the complex programmable logic device on the target board, so as to control a state of the indicating apparatus to the current pending setting state through the complex programmable logic device on the target board.

21. The method for controlling an indicating apparatus according to claim 1, after determining that the update of the complex programmable logic device is complete, the method further comprises:
restarting the baseboard management controller, and rewriting, by the baseboard management controller, the complex programmable logic device once after being restarted, and the indicating apparatus remains in an original state.
